(19) United States
(12) Patent Application Publication
(10) Pub. No.: US 2010/0047540 A1
(43) Pub. Date: Feb. 25, 2010

(54) ACTUATOR USING A MULTILAYER COMPOSITE MATERIAL

(75) Inventors: Hiroshi Asanuma, Chiba-shi (JP); Toshiyuki Nakata, Chiba-shi (JP); Toshiaki Tanaka, Chiba-shi (JP)

Correspondence Address: KNOBBE MARTENS OLSON & BEAR LLP, 2040 MAIN STREET, FOURTEENTH FLOOR, IRVINE, CA, 92614, US

(73) Assignee: National University Corporation Chiba University, Chiba-shi (JP)

(21) Appl. No.: 12/196,043

(22) Filed: Aug. 21, 2008

(51) Int. Cl. B32B 17/06

(52) U.S. Cl. 428/212

(57) ABSTRACT

There provided an actuator employing laminated composite materials which exhibit both large deformation and high power output. In order to achieve the invention, the actuator comprises a pair of substrates having different coefficients of thermal expansion and an insulating layer disposed between said pair of substrates; and an elastic layer disposed between said plurality of laminated composite materials.

### BACKGROUND

1. Field of the Invention

The present invention relates to an actuator, in particular, to an actuator that employs a laminated composite material.

2. Description of the Related Technology

In recent year, the general idea of providing a smart material by adding functions of intelligent response, self-diagnosis and the like to a material in order to aim the realization of the improvement of liability, higher efficiency, maintenance-free of the conventional mechanical systems has attracted considerable attention.

Among them, for one of the smart materials having a capability to give an intelligent response, a laminated composite material which is comprised by laminating CFRP (Carbon Fiber Reinforced Plastic) having a small coefficient of thermal expansion in the orientation of the fiber and a large coefficient of thermal expansion in the orthogonal direction with a metal having a large isotropic coefficient of thermal expansion so that the laminated composite material is capable of being deformed in one direction in response to heating up the carbon fibers by conducting electricity or changes of the ambient temperature as well as providing work to the outside thereof as an actuator, which is described, for example, in Japanese Patent Laid-Open Publication No. H10-138,380.

### SUMMARY OF CERTAIN INVENTIVE ASPECTS

However, it is considered that there is a need to reduce the thickness of the metal layer to enlarge the deformation thereof, for the deformation of the laminated composite material as described in the above publication, while there is a need to increase the thickness of the metal layer to raise the power output thereof that is the work to the outside. In other words, there is a trade-off relationship between the enlargement of the deformation and the increased power output of the material.

Thus, the object of the present invention is to solve the above problem and to provide an actuator using a laminated composite material which enables both large deformation and the high output.

The present inventors have concentrated and studied on the above subject and found that the laminated composite material providing both large deformation and high output can be obtained by laminating further layer of an elastic body, thereby achieving the present invention.

That is, one aspect of the present invention to solve the above problem is an actuator comprising a plurality of laminated composite materials including a pair of substrates having different coefficients of thermal expansion and an insulating layer provided between the pair of substrates; and an elastic layer provided between the plurality of laminated composite materials.

In this aspect, it is also preferable that the elastic layer is comprised of an insulating rubber.

In this aspect, it is yet also preferable that one of the pair of substrates is comprised of aluminum, magnesium, titanium, iron, copper, zinc or an alloy containing at least any one of them, while the other of the pair of substrates is comprised by a preimpregnation sheet containing at least any one of carbon fibers, boron fibers, glass fibers, silicon carbide fibers or aramide fibers. Also, it is preferred that the carbon fibers of the preimpregnation sheet are oriented in the deformation direction of the laminated plate. Moreover, it is preferred embodiment in which the insulator layer is comprised of at least any one of glass fiber reinforced resin, aramide fiber reinforced resin, insulating resin film and a metal oxide membrane.

According to the present invention as mentioned above, an actuator using laminated composite materials enabling both large deformation and high power output can be provided.

### BRIEF DESCRIPTION OF THE DRAWINGS

The embodiments will be better understood from the Detailed Description of Embodiments and from the appended drawings, which are meant to illustrate and not to limit the embodiments, and wherein:

FIG. 1 is a schematic view illustrating the actuator of Embodiment, Example 1 according to the present invention;

FIG. 2 illustrates the relationship between the curvature and the hardness of the rubber at the room temperature (293 K) of Example 1 according to the present invention;

FIG. 3 illustrates the output and its dependency on temperatures in Example 1 according to the present invention;

FIG. 4 illustrates the dependency on temperatures of the curvature of the actuator of Example 1 according to the present invention;

FIG. 5 is a schematic view illustrating the actuator of Example 2 according to the present invention;

FIG. 6 illustrates the relationship between the curvature and the aria ratio at the room temperature of Example 2 according to the present invention;

FIG. 7 illustrates the output and its dependency on temperatures in Example 2 according to the present invention;

FIG. 8 is a schematic view illustrating the actuator of Example 3 according to the present invention; and

FIG. 9 illustrates the relationship between the curvature and the area ratio at the room temperature of Example 3 according to the present invention.

### REFERENCE NUMBERS

1: laminated composite materials;
2: elastic layer
11: pair of substrates;
12: insulating layer; and
13: electrodes

### DETAILED DESCRIPTION OF CERTAIN INVENTIVE EMBODIMENTS

The present invention will now be explained with reference to the accompanied drawings in below. It should be understood that the present invention can be performed in various embodiments and the present invention is not intended to be limited to the following embodiments. In this explanation, the same numerical reference is applied to the same component or a part having the equivalent function and, thus, reduplication of the explanation is abbreviated here.

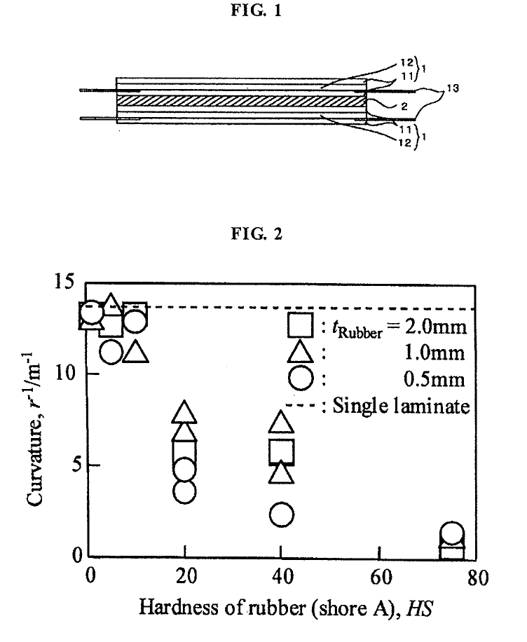

FIG. 1 is a schematic view illustrating the actuator according to the embodiment of the present invention (hereinafter, referred to as “the present actuator”). The present actuator comprises a plurality of laminated composite materials 1 including a pair of substrates 11, having different coefficients of thermal expansion, and an elastic layer disposed between said plurality of laminated composite materials 1.

The pair of substrates 11 of the laminated composite materials are of being different coefficients of thermal expansion each other and, thus, act as an actuator by using the difference between these different coefficients of thermal expansion. More specifically, though each substrate begins to expand upon heating the pair of substrates, there generated the difference of thermal expansion between these pair of substrates which becomes stress and will appear as the deformation of the laminated composite materials. By controlling this deformation, the materials can be performed as an actuator. For materials of the pair of substrates 11, at least one of the substrates is preferred to be, for example, a metal plate having conductivity to generate heat, but it is not particularly limited thereto. In particular, it is preferred that the metal exhibits a large coefficient of thermal expansion. Specifically, one of substrates may preferably be made of aluminum, magnesium, titanium, iron, nickel, copper, zinc or an alloy containing at least one of them.

On the other hand, for the material of the other substrate of the pair of substrates 11 is not specifically limited and it is also preferred to employ a material having a small coefficient of thermal expansion. For an example thereof, a fiber reinforced resin may suitably be employed, including, more specifically, a carbon fiber reinforced preimpregnation sheet. When the preimpregnation sheet is used, it is desirable that the carbon fibers are oriented into the deformation direction of the laminated composite materials. In such a case, the deformation of the substrate made of CFRP can be controlled in directions other than the deformation direction by generating thermal expansion thereof, similar to the metallic plate. Furthermore, an electrode 13 is desirably provided to these substrates whereby the thermal deformation thereof can easily induced by applying an electric current through the electrode to generate heat. In particular, the preimpregnation sheet containing carbon fibers is also useful as a heater. In the preimpregnation sheet may contain boron fibers, glass fibers, silicon carbide fibers or aramide fibers other than carbon fibers. The preimpregnation sheet containing carbon fibers are suitable since it can be act as a heater and when the function thereof as a heater is week, it is also useful to dispose a conventional heating element such as a Nichrome (trademark) wire to secure the function. For the material for preimpregnation sheet, resins such as polyester resins and epoxy resins may suitably be employed but not limited thereto.

The insulating layer 12 disposed between the pair of substrates to join them together, though which is not specifically restricted as long as it is capable of joining those substrates, is desired to be made of a high strength material such as a resin containing, for example, aramide fibers not to buffer the thermal deformation of the pair of substrates. Also, a glass fiber reinforced resin, an insulating resin film, a metal oxide membrane and the like other than aramide fibers may suitably be employed for the insulating layer 12. In particular, when the insulating layer 12 is comprised by a metal oxide membrane and one of the pair of substrates is a metallic plate, the present object can be realized only by subjecting it to oxidizing treatment, thereby providing the advantage of its easy production.

The present actuator is characterized in that further a plurality of laminated composite materials 1 as described in above and an elastic layer disposed therebetween are used. Accordingly, by using the present actuator, both large deformation and high power output can be achieved. Herein, the insulating layer is a layer containing a substance having elasticity and rubber, for example, is suitably employed therefore but not limited thereto as long as it exhibits elasticity. For the hardness of the elastic layer, it is desirably in the range from A0HS to A80HS, preferably not more than A60HS, more preferably not more than A40HS, depending on the thickness of the elastic layer. When the hardness is more than A80HS, the laminated composite materials could be rigid even though further materials are laminated thereon and have similar structure of the conventional laminated composite materials, resulting in it difficult to achieve both large deformation and high power output. The elastic layer may be disposed on the whole surface between the plurality of laminated composite materials or the layer may be divided into a plurality thereof and disposed on the surface between the plurality of laminated with a certain intervals between the plurality of the divided layers. Accordingly, the flow of a gas or a liquid can be provided through the laminated composite materials to perform active heat exchange between the laminated composite materials and the elastic layer(s), thereby improving the response of the actuator by its effective cooling and heating. When a certain substance is inserted into this space, the weight of the materials as an actuator can be controlled (including the adjustment of the position of the center of gravity thereof). When the flow of a gas or a liquid is provided to the space, it is also possible to generate changes of the temperature or the pressure by a chemical reaction occurred at the space between the laminated composite materials.

According to the present actuator, both large deformation and high power output thereof can be realized. Further, the number of the laminated composite materials is not specifically restricted so long as it is 2 or more and, thus, an actuator provided with multiple composite materials and elastic layers disposed on every material, or between materials.

### Embodiment 1

The actuator according to the embodiment as described in above was actually produced and the functions thereof as an actuator were confirmed which is explained in below.

The actuator of the embodiment according to the present invention employed a pure aluminum plate (A1050-H24) for one of a pair of substrates and a CFRP plate for the other substrate. The CFRP plate is useful as a low heat expanding material and a heater. For an insulating layer for joining these pair of substrates, an epoxy adhesive film was employed and a copper foil was used as an electrode to connect the CFRP layer. Further, in this embodiment, rubbers were used as an elastic layer and total 18, 6 different hardness and 3 different thickness, rubbers were employed as shown in Table 1 in below.

TABLE 1

| | Hardness (HS) | Thickness (mm) |
|---|---|---|
| EPDM | A1 | 0.5 |
| EPDM | A5 | 1.0 |
| EPDM | A10 | 2.0 |
| EPDM | A20 | |
| SBR/NR | A40 | |
| EPDM | A75 | |

Now, the method for producing the actuator of this embodiment according to the present invention will be explained. For the pair of substrates, the pure aluminum plate (0.2 mm of thickness) and the CFRP preimpregnation sheet (0.12 mm of thickness) were prepared, and a rubber sheet having 40 mm width and 80 mm length and a copper foil having 40 mm width and 50 mm length for an electrode were cut; surfaces of the pure aluminum plate and the copper foil were polished with waterproof garnet papers of #320 and #600, respectively. Firstly, the CFRP preimpregnation sheet was cured under the condition of 453 K, 0.1 MPa and 3.6 ks. Then, it was laminated together with a rubber to be cured. The structure of the actuator produced in this embodiment is the same as that of the actuator shown in FIG. 1 in which two laminated composite materials are used and provided with a rubber therebetween. The distance between the electrodes were prepared so as to be 60 mm and the pure aluminum plate and the CFRP preimpregnation sheet were adhered to each other by epoxy resin (the thickness after curing was 0.04 mm).

At first, the curvature at a room temperature was measured. The measurement of the curvature was performed wile holding the actuator by a jig made of ceramic and with a laser displacement meter (visible light laser displacement sensor LK-1000, manufactured by Keyence Corporation, Japan). FIG. 2 shows the relationship between the curvature and the hardness at the room temperature (293 K). In FIG. 2, the dotted line indicates curvature values of the single composite material without through an elastic layer.

As a result shown in FIG. 2, it was confirmed that the more the hardness of the rubber was high, the more the curvature of the laminated composite material was low. It is considered that the shearing between the laminated composite materials can be relieved as the hardness is lowered. Therefore, the desirable value is more than 0 and less than A80HS, preferably A60HS or below, more preferably A40HS or less, yet further preferably less than A20HS. In particular, it is confirmed that almost the same curvature as that of single laminated composite material can be attained when the hardness of the rubber is less than A20H. Although this measurement was applied to various rubbers having different thicknesses (2.0 mm, 1.0 mm and 0.5 mm), there was no significant difference of the curvature by varying the thickness of the rubber in the measured range. Therefore, though the thickness of the rubber is not specifically restricted, for example, it is considered that the rubber having a thickness ranging 2 mm or less is desired.

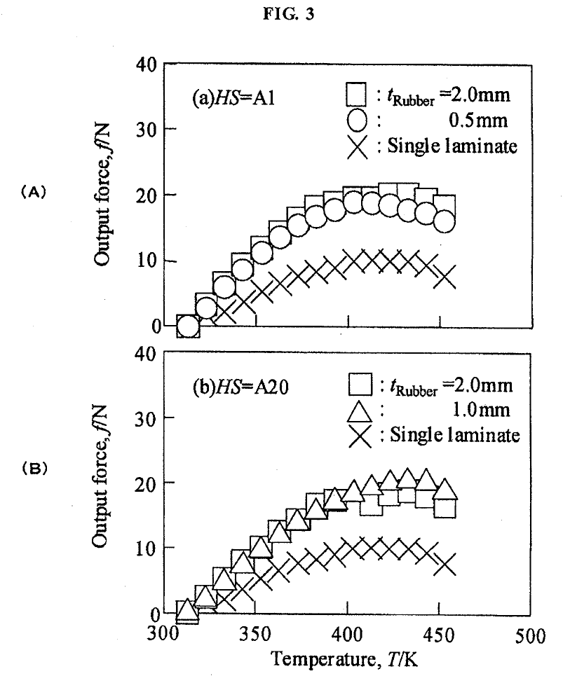

Furthermore, the power output and its dependency on a temperature were determined. FIGS. 3(A) and 3(B) show the results thereof. The power output was measured in such that an electron portion of a copper foil was connected to a power source device (a variable direct current low voltage and low electric current power source, PAK/20-18A manufactured by Kikusui Electronics Corporation) and current was applied to heat up to temperature of 313 K and maintained that temperature and, then, a punch made of ceramic equipped with a load cell is contacted from the upper side to the center of the actuator and further current was applied thereto to provide over heat to measure the forth of the sample to push up the fixing punch as an output. The temperature of the sample was measured by the K type thermocouple fixed to the center part of the CFRP side.

FIG. 3(A) shows the result of the test for the rubber having the hardness of A1HS and FIG. 3(B) shows the result of the rubber having the hardness of A20HS. The temperature was raised up and lowered down from 313 K to 453 K and the curvature of the sample was measured at every 20 K.

As a result, it was found that the power output of the present actuator became about twice of that of the single laminated composite material regardless of the single laminated composite material. In other word, it was confirmed that the power can be transmitted without any affection to the hardness or the output in this range as well as both curvature and power output can be achieved at the same time.

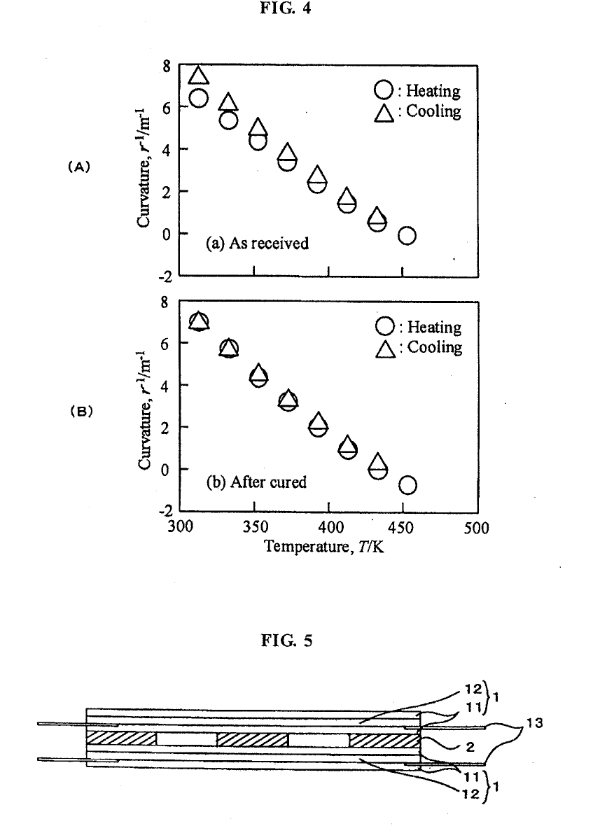

On the other hand, since the thermoremanent stress during the production is remained in the actuator, there is hysteresis in the dependency on the temperature. Because of the possibility of the reduction of the accuracy during the control the performance of the actuator, it is preferred to apply after curing to re-heat to a temperature above the glass transition temperature of the CFRP and maintain it. FIGS. 4(A) and 4(B) show the results before and after the after curing (unloading, 433 K, 7.2 ks), respectively. As shown in FIG. 4(B), almost all the hysteresis can be eliminated by the after curing.

### Embodiment 2

This embodiment is the same as Embodiment 1 except for the structure of the elastic layer. FIG. 5 is a cross sectional view illustrating one example of the actuator according to the present invention (wherein, the elastic layer is divided into three parts).

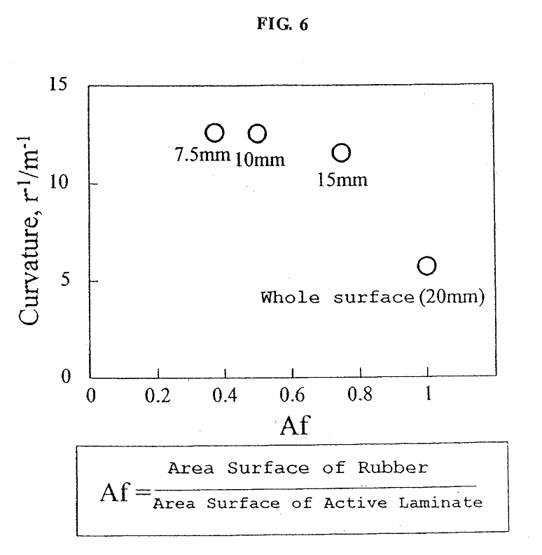

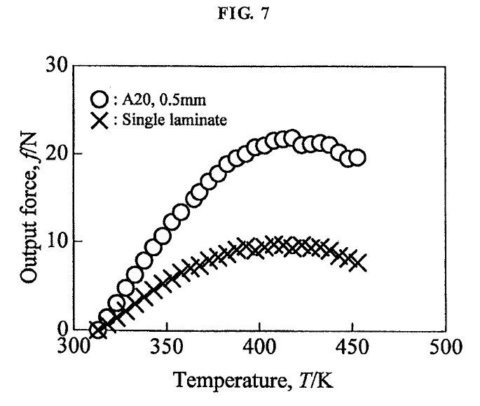

In this embodiment, the elastic layer disposed between the laminated composite materials is divided into a plurality parts thereof and resulting divided parts of layer are contributed and placed between the materials (with even intervals between adjacent parts of layer) (in other words, this actuator has spaces between the laminated composite materials). In this embodiment, every sample has 3 divided parts of layer and the ratio of area of the elastic layer (rubber) to the whole surface area was varied by varying the width of the divided parts of the layer (hereinafter, just called as “ratio”). The conditions of every sample; the measurement results of the curvatures for every sample; and the measurement result of the power output for sample 1 as one example, are shown in Table 2, FIG. 6 and FIG. 7, respectively, in which the experimental conditions and the like were same as those in Embodiment 1. Also, in any samples, the hardness of the elastic layer was A20HS and the thickness thereof was 2.0 mm.

TABLE 2

| | Width | Area | Area of laminated | Ratio |
|---|---|---|---|---|
| | per sampe | of elastic layer | composite material | (%) |
| Sample 1 | 7.5 mm | 7.5 × 40 × 3 mm² | 60 × 40 mm² | 37.5 |
| Sample 2 | 10 mm | 10 × 40 × 3 mm² | 60 × 40 mm² | 50 |
| Sample 3 | 15 mm | 15 × 40 × 3 mm² | 60 × 40 mm² | 75 |
| Sample 4 | 20 mm | 20 × 40 × 3 mm² | 60 × 40 mm² | 100 |

The results as shown in FIG. 6, in Sample 4 the curvature was approximately 5 m−1 and it could be confirmed that the curvature was significantly improved by contributing and arranging the parts of the elastic layer with spaces as well as this curvature can be closed to the curvature of a single layer laminated material. That is to say, the preferred range, which is not specifically limited so long as the elastic layer is divided and dispersed to dispose, is 75% or below, preferably 50% or below.

Moreover, for the power output, even though the elastic layer was divided and dispersed, the power output thereof was about twice as compared with the single laminated composite material as shown in FIG. 7 and it was confirmed that both large curvature and large power output can be achieved.

Although the principle for explaining this result is not partially unclear, it can be considered that the ratio of the area of the elastic layer relative to the whole area where the laminated composite materials are opposed to each other largely effects thereon and the number of parts of divided elastic layer, the width and the depth thereof and the like can be appropriately regulated, thus, it can be assumed that they are not limited to those of this embodiment.

### Embodiment 3

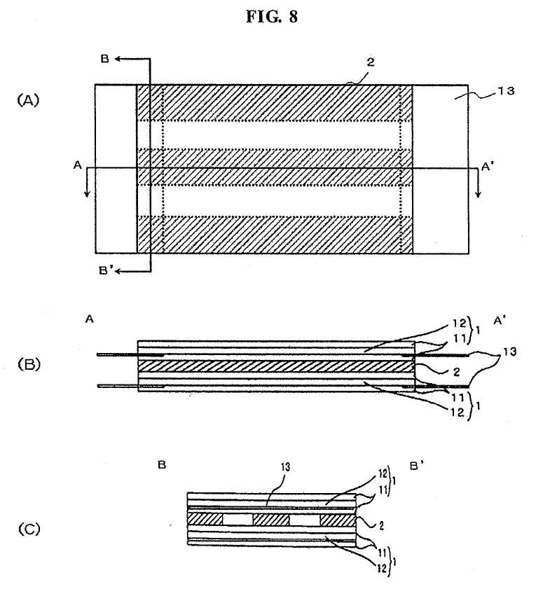

This embodiment was almost the same as Embodiment 2 except for the orientation where the elastic layer was disposed. FIG. 8 is a schematic view illustrating the actuator of this embodiment according to the present invention. A plurality of elastic bodies 2 are dispersed to place such that spaces are formed so as to approximately perpendicular to the direction where the electrodes 13 are opposed to each other as shown in FIG. 5, while, in this embodiment, the elastic bodies 2 are dispersed to place such that spaces are formed so as to approximately parallel to the direction where the electrodes 13 are opposed to each other as shown in FIG. 8. FIG. 8(A) shows the actuator viewing from the top side; FIG. 8(B) is a cross sectional view at the line A-A′ in FIG. 8(A) (the cross sectional view of the actuator sectioned in the direction approximately parallel to the direction where the electrodes 13 are opposed to each other); and FIG. 8(C) is a cross sectional view at the line B-B′ in FIG. 8(A) (the cross sectional view of the actuator sectioned in the direction approximately perpendicular to the direction where the electrodes 13 are opposed to each other). As well, the number of the divided parts of the elastic layer is 3 (three) in any cases in this embodiment, wherein the hardness and the thickness of the elastic layer are A20HS and 2.0 mm, respectively.

TABLE 3

| | | | Area of | |
|---|---|---|---|---|
| | | | laminated | |
| | Width | Area of | composite | |
| | per Sample | elastic layer | material | Ratio (%) |
| Sample 5 | 5 mm | 5 × 60 × 3 mm² | 60 × 40 mm² | 37.5 |
| Sample 6 | 6.7 mm | 6.7 × 60 × 3 mm² | 60 × 40 mm² | 50 |
| Sample 7 | 10 mm | 10 × 60 × 3 mm² | 60 × 40 mm² | 75 |
| Sample 8 | 13.3 mm | 13.3 × 60 × 3 mm² | 60 × 40 mm² | 100 |

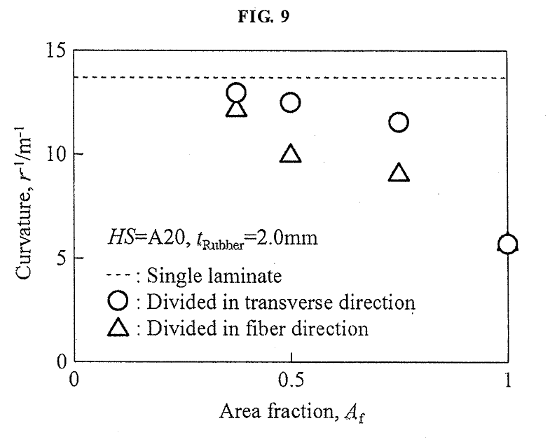

The results are shown in FIG. 9. In the figure, the results each indicated by a triangle are of this Embodiment, while there indicated by a circle is the same result as that of Embodiment 2. In this results, it could be confirmed that when the area of the elastic layer is reduced and the same curvature in Embodiment 2 can be achieved in this embodiment.

Accordingly, it was confirmed that the actuator employing the laminated composite material being capable of performing both large deformation and high power output can be provided by the actuator of this embodiment of the present invention.

As described in above, the present invention is industrially applicable as a various actuators. The present invention can be widely applied to a manipulator, a flow control valve, a pressure regulation valve and the like but it is not limited thereto.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well. Accordingly, the scope of the present invention is defined only by reference to the appended claims.

What is claimed is:

1. An actuator comprising a plurality of laminated composite material including a pair of substrates having different coefficients of thermal expansion and an insulating layer disposed between said pair of substrates; and an elastic layer disposed between said plurality of laminated composite materials.

2. The actuator according to claim 1, wherein said elastic layer is made of an insulating rubber.

3. The actuator according to claim 1, wherein one of said pair of substrates is comprised by using aluminum, magnesium, titanium, nickel, iron, copper, zinc, or an alloy containing at least one of them.

4. The actuator as set forth in claim 3, wherein the other of said pair of substrates comprising by using a preimpregnation sheet containing at least one of carbon fibers, boron fibers, glass fibers, silicon carbide fibers or aramide fibers.

5. The actuator according to claim 4, said carbon fibers said preimpregnation sheet are oriented in the direction of the deformation of said laminated plate.

6. The actuator according to claim 1, wherein said insulating layer is comprised by using at least any one of a glass fiber reinforced resin, an aramide fiber reinforced resin, an insulating resin film, and a metal oxide membrane.
